(19) United States
(12) Patent Application Publication
(10) Pub. No.: US 2025/0339987 A1
(43) Pub. Date: Nov. 6, 2025

(54) KNIFE RETENTION AND SPEED DRAW MECHANSIM

(71) Applicant: Todd Rexford, Florissant, CO (US)

(72) Inventor: Todd Rexford, Florissant, CO (US)

(21) Appl. No.: 19/196,684

(22) Filed: May 1, 2025

Related U.S. Application Data
(60) Provisional application No. 63/641,403, filed on May 1, 2024.

(51) Int. Cl. B26B 29/02

(52) U.S. Cl. CPC B26B 29/025

(57) ABSTRACT

A knife retention system includes an longitudinally elongated sheath body configured for holding a blade of a knife along an edge of the blade, a locking cam attached to the sheath body through an attachment, and a spring pad pre-biased to supply a force to rotate the locking cam. The locking cam is configured to rotate about the attachment; the locking cam includes a switch and an insert, and the insert is configured to be inserted into a handle of the knife when the blade is held by the sheath body. The force is configured to keep the insert inserted into the handle. The switch is configured to receive a counter-force countering the force to rotate the locking cam to release the insert from the handle.

### CROSS REFERENCE TO RELATED APPLICATIONS

The present application claims the benefits of and priority, under 35 U.S.C. § 119(e), to U.S. Provisional Application Ser. No. 63/641,403, filed May 1, 2024, which is fully incorporated herein by reference.

### BACKGROUND OF THE INVENTION

### Field of the Invention

The present invention generally relates to knife sheath system, and more particularly to a knife retention and speed draw system.

### Description of the Related Art

There are knife sheath systems in the related art.

U.S. Pat. No. 2,618,057 to Gibson, herein incorporated by reference, discloses “a self-locking knife-sheath.”

U.S. Pat. No. 3,958,330 to Hutchens, herein incorporated by reference, discloses “a combination of a knife and scabbard [ ], the knife having a lateral projection on its handle and the scabbard having a stop on the inner surface of one side edge thereof for engaging the projection when the knife is inserted into the scabbard, preventing accidental release of the knife. A slot opening in the upper part of the scabbard opposite the stop can be widened by forcing the knife handle into it to disengage the projection from the stop, permitting the knife to be withdrawn from the scabbard. A strap and fastener releasably prevent widening of the slot opening to lock the knife in the scabbard.”

U.S. Pat. No. 4,964,554 to Collins, herein incorporated by reference, discloses “a knife and sheath assembly, the knife having a blade and a hilt with a guard, the sheath having a closed portion adapted to receive the blade and an open portion adapted to abut the hilt and guard. A bolt and a spring pad are slidably contained within a channel in the sheath. A portion of the bolt protrudes outwards from the channel and engages the side of the guard. The open portion of the sheath has a guide with a curved portion that causes the hilt of a knife being inserted to engage the bolt and move it from the locking position to the unlocking position until the knife is inserted far enough. Then a stepped portion of the guide causes the hilt to seat against the sheath and to disengage the bolt which slides to the locking position, thus preventing removal of the knife from the sheath by the cooperation of the sheath and the bolt. Pushing the bolt away into the channel releases the knife.”

There are deficiencies in the related art. For example, awkward and/or multiple hand movements are needed to draw and release the knives from their respective sheaths, e.g., requiring directly upward, vertical or angled, and/or other complicated draw movements unnatural to human hand when drawing the knives. In particular, when a knife is anchored to a waist belt, the upward draw movement requires the human hand, with arms extended, to pull up the length of the knife blade, which requires unnatural hand and arm movement and additional efforts to be expended, and slowing the draw. Additionally, the releases to various lock mechanisms for securing the knives to the sheaths are inconvenient to the draw, e.g., requiring further unnatural adjustments to the hand grip and/or movements and/or requiring the use of both hands to work to release the lock mechanisms and the knives during a draw, which further slow the draw. Accordingly, the speed, efficiency, effort, and safety of drawing the knife is affected, along with other deficiencies.

### SUMMARY OF THE INVENTION

Accordingly, the invention is directed to a knife retention and speed draw system that substantially obviates one or more of the problems due to limitations and disadvantages of the related art.

An advantage of an embodiment is to provide a knife sheath system that facilitate fast and easy draw of a fixed blade knife.

Another advantage of an embodiment is to provide a knife sheath system that facilitate the draw of the knife through the natural movements of the human hand.

Yet another advantage of an embodiment is to provide a knife retention mechanism that supports full retention and security of the blade, while facilitating its quick release and deployment during use.

A further advantage of an embodiment is to provide a knife retention and speed draw mechanism that is operable with one hand and immediately usable with that same hand and in the same grip upon the draw.

Additional features and advantages of the invention set forth in the description which follows and in the art will be apparent from the description, or may be learned by practice of the invention. The objectives and other advantages of the invention will be realized and attained by the structure particularly pointed out in the written description and claims hereof as well as the appended figures.

In an embodiment, a knife retention system comprises an longitudinally elongated sheath body configured for holding a blade of a knife along a cutting edge of the blade, wherein a top edge of the blade is uncovered by the sheath body; a locking cam attached to the sheath body, wherein the locking cam is configured to attach to a handle of the knife when the blade is held by the sheath body in a locked position; and a release mechanism configured to hold the locked position and to release the blade from the sheath body in an unlocked position upon an application of a force. the release mechanism comprises a spring pad. A locking cam attached to the sheath body through an attachment, wherein the locking cam is configured to rotate about the attachment. The force is applied by a finger of a hand holding the handle.

In another embodiment, a knife retention system comprises an longitudinally elongated sheath body configured for holding a blade of a knife along an edge of the blade; a locking cam attached to the sheath body through an attachment, wherein the locking cam is configured to rotate about the attachment, wherein the locking cam comprises a switch and an insert, and wherein the insert is configured to be inserted into a handle of the knife when the blade is held by the sheath body; and a spring pad pre-biased to supply a force to rotate the locking cam, wherein the force is configured to keep the insert inserted into the handle, wherein the switch is configured to receive a counter-force countering the force to rotate the locking cam to release the insert from the handle. The knife retention system further comprises comprising a wall stop configured to stop the locking cam when the locking cam rotates to a position. The knife retention system further comprises a spindle attached to the locking cam, wherein the spring pad supplies the force to an extension of the spindle. The insert is inserted into a corresponding track in the handle. The insert comprises an extrusion, and wherein the track comprises a recess corresponding to the handle. The counter-force is received by a finger of a hand holding the handle. The sheath body uncovers a top edge of the blade. The locking cam is attached to one side of the sheath body. The locking cam is attached to the sheath body at a position near an end of the sheath body.

In yet another embodiment, a knife retention system comprises a knife; an longitudinally elongated sheath body configured for holding a blade of the knife along an edge of the blade; a locking cam attached to the sheath body through an attachment, wherein the locking cam is configured to rotate about the attachment, wherein the locking cam comprises a switch and an insert, and wherein the insert is configured to be inserted into a handle of the knife when the blade is held by the sheath body; and a spring pad pre-biased to supply a force to rotate the locking cam, wherein the force is configured to keep the insert inserted into the handle, wherein the switch is configured to receive a counter-force countering the force to rotate the locking cam to release the insert from the handle. The sheath body uncovers a top edge of the blade. The force is applied by a finger of a hand holding the handle. The knife retention system further comprises a wall stop configured to stop the locking cam when the locking cam rotates to a position. The knife retention system further comprises a spindle attached to the locking cam, wherein the spring pad supplies the force to an extension of the spindle. The insert is inserted into a corresponding track in the handle. The insert comprises an extrusion, and wherein the track comprises a recess corresponding to the handle.

It is to be understood that both the foregoing general description and the following detailed description are exemplary and explanatory and are intended to provide further explanation of the invention as claimed.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible, utilizing, alone or in combination, one or more of the features set forth above or described in detail below.

### BRIEF DESCRIPTION OF THE FIGURES

The accompanying figures, which are included to provide a further understanding of the invention, are incorporated in and constitute a part of this specification, illustrate embodiments of the invention and together with the description serve to explain the principles of the invention.

FIG. 1 illustrates a perspective view of an exemplary knife retention system according to an embodiment.

FIG. 2A illustrates a right side view of a sheath of the knife retention system. FIG. 2B illustrates a left side view of the sheath. FIG. 2C illustrates a cross section view of the sheath.

FIG. 3 illustrates a close up of a cross section view of a right side of the knife retention system in an unlocked position.

FIG. 4 illustrates an exploded view of a locking cam and a spindle of the knife retention system.

FIG. 5A illustrates a right side view of the knife retention system. FIG. 5B illustrates a left side view of the knife retention system.

### DETAILED DESCRIPTION

Reference will now be made in additional detail to an embodiment of the present invention, example of which is illustrated in the accompanying figures.

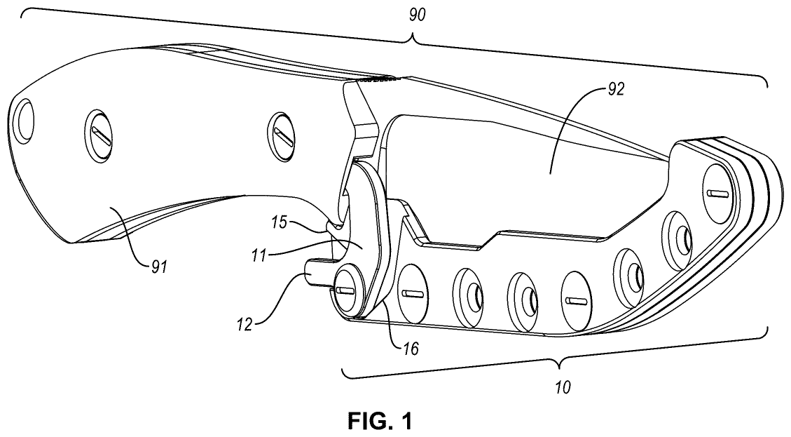

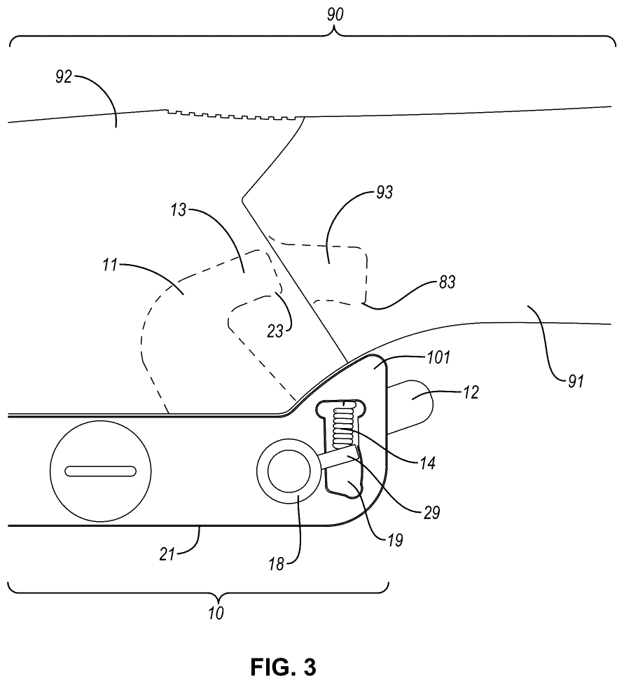

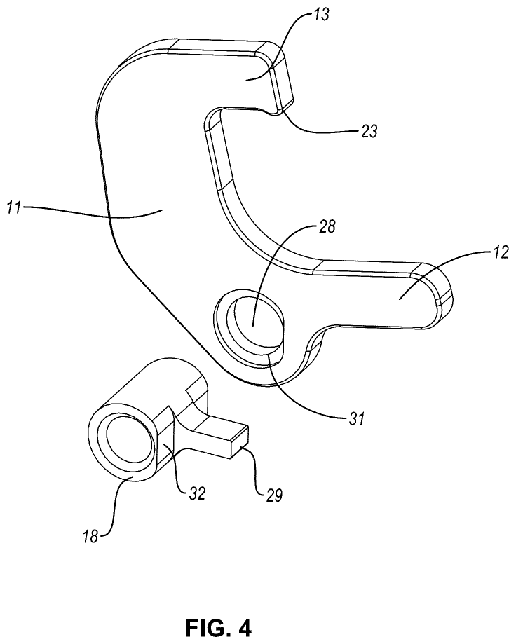

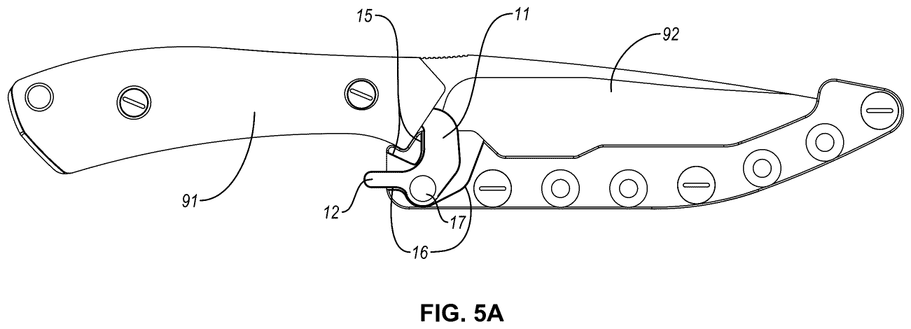

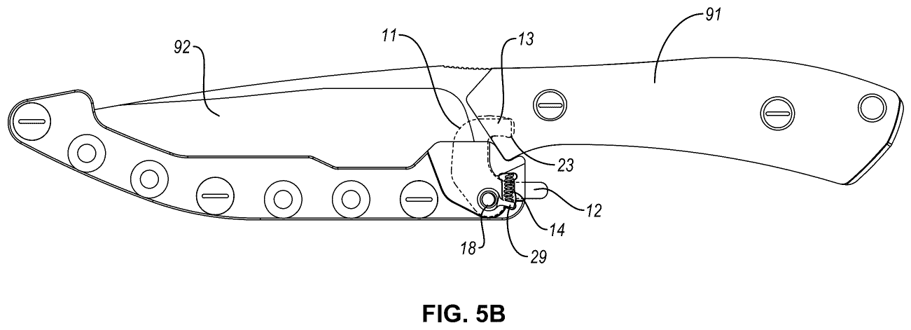

With reference to FIGS. 1-5B, a knife retention system includes a sheath body 10. The sheath body 10 is configured to accommodate a corresponding knife 90, which include a blade 92 and a knife handle 91. The sheath body 10 includes an upper edge 22, which includes a longitudinal opening along the upper edge 22 that allows the knife edge 93 of the blade 92 to be inserted into the body of the sheath body 10 and held against the interior of the lower edge 21 of the sheath body 10. In an embodiment, the sheath body 10 is fitted to the corresponding knife 90 such that the knife 90 is held in place in the sheath body 10 with minimal allowance for forward, back, and/or side movements along the blade 92 of the knife.

A locking cam 11 is mounted to one side (e.g., the right side as illustrated in FIGS. 1-5) of an end of the sheath body 10 proximate to the handle 91 by attachment 17 (e.g., screw, bolt, or other attachment), such that the locking cam 11 is rotatably fixed to one side of the sheath body 10. The locking cam 11 includes a switch portion 12 and an insert portion 23.

The knife handle 91 may be scales, guard, and/or other extrusion and includes an interior locking track 93 corresponding to and for receiving the insert portion 23. When the blade 92 is inserted into the sheath body 10 and the insert portion 23 is inserted into the locking track 93, the knife retention system is in a locked position where the knife 90 is locked to the sheath body 10, thereby keeping the blade edge of blade 92 within the body of the sheath body 10 against interior of the lower edge 21. In the unlocked position where the insert portion 23 is removed from the locking track 93, the knife 90 is not locked to the sheath body 10 and may be released from the sheath body 10 for use.

In an embodiment, the insert portion 13 may include a further extrusion 23 (and corresponding recess 23 in the locking track 93) and/or other detent features for further securing the insert portion 13 into the locking track 93 (e.g., requiring a stronger initial force to rotate the insert portion 23 from the locking track 93 from the locked position). In other embodiments, other shapes for the locking cam 11 (and corresponding shape for the locking track 93) and/or other or additional extrusions and corresponding recesses to the locking cam 11 and the locking track 93 may serve similar purpose. In another embodiment, spring and/or ball/pin detents may be added to the locking cam 11 or the spindle 18 to further secure the insert portion 13.

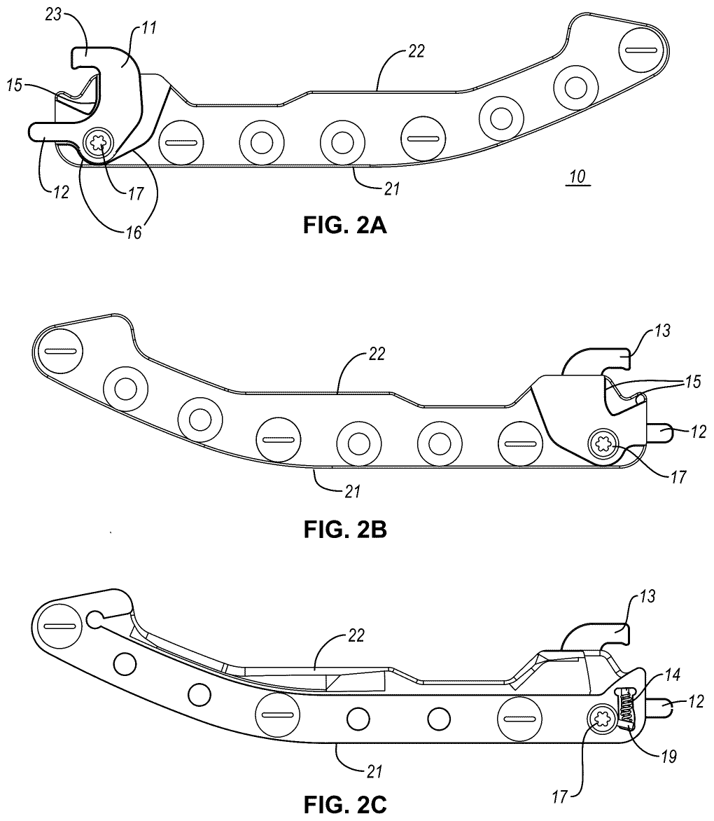

In an embodiment, the locking cam 11 may be kept in the locking track 93 (and keeping the knife retention system in the locked position if no other force is applied) by spring pad 14 (and/or other mechanism for providing force or tension). The spring pad 14 may be embedded in spring pad slot 19, which may be an enclosed interior space of the sheath body 10 as shown in cross section views (e.g., FIGS. 2C, 3, and 5B). The spring pad 14 pushes against an extension 29 of the spindle 18. The spindle 18 is attached to the locking cam 11 through insertion into the opening 28 of the locking cam 11. The exterior wall of the spindle 18 may include extrusions 32 (e.g., male extrusions), and the interior wall of the opening 28 may include extrusions 31 (e.g., female extrusions), such that when the spindle 18 is inserted the opening 28, the locking cam 11 will rotate with the spindle 18, and independent rotation of the locking cam 11 and the spindle 18 is prevented. The spring pad 14 may be pre-biased to push against the extension 29, which rotates the spindle 18 together with the locking cam 11 such that the insert portion 13 is kept in the locking track 93, thereby keeping the retention system in the locked position.

To release the insert portion 13 from the locking track 93 (and putting the retention system in the unlocked position), an external force may be applied (e.g., by a user's finger or hand) to the switch portion 12 (e.g., lifting the switch portion 12), which rotates the locking cam 11 and the insert portion 13 out of the locking track 93. It is noted that rotating the locking cam 11 also rotates the spindle 18 and extension 29, which pushes against the spring pad 14 and tensions the spring pad 14. When the external force is no longer applied to the switch portion 12, the tensioned spring pad 14 will again push against the extension 29 and rotate the spindle 18 and the locking cam 11, thereby putting the insert portion 13 back into the locking track 93 (and putting the retention system back into the locked position).

In the exemplary embodiment, spring pad 14 is shown as a coil spring. In an embodiment, torsion springs may be used instead of coil springs to add moment force to the spindle. In a further embodiment, the spindle 18 may be replaced with incorporating various spring styles into locking cam 11 for creating the moment force. In another embodiment, a fastener may be used as the spindle 18, and a torsion spring may be placed inside locking cam 11.

In an embodiment, the sheath body 10 includes raised wall stops 15 along the rotational path of the locking cam 11, which may stop the rotation of the locking cam 11 when the corresponding edges of the locking cam 11 contacts the wall stops 15, thereby limiting the range of the rotation of the locking cam 11 and preventing over rotation of the locking cam 11). In an embodiment, guards 16 may further define the range of the rotation of the locking cam 11 and further prevent over rotation of the locking cam 11.

In an embodiment where a sheath body does not restrict the rotational path of the locking cam (e.g., the shape of the knife does not facilitate restriction by the sheath on rotational movement of the locking cam beyond a certain threshold), the rotational movement of the locking cam may be limited by adjusting the length of the track, geometry of the locking cam, and/or the amount of rotation of the locking cam allowed by the wall stops. For example, if the blade 92 is shaped such that the bottom edge of the blade 92 that is proximal to the knife handle 91 (and distal to the tip of the blade) is straighter rather than angled and/or without a matching angled stop 101 provided by the sheath body 90, the knife 90 may slip longitudinally rearward out of the sheath body 90 with the configuration of locking cam 11 and locking track 93 being about straight and parallel to the length of the knife blade 92 and/or knife handle 91 as shown. In another embodiment, the locking cam 11 and locking track 93 may be modified (e.g., by extending and lengthening the locking track 93 and corresponding locking cam 11, following the circular path consistent with the spin of the locking cam 11 and the spindle 18, to include a component more perpendicular to the length of the blade 92 and/or knife handle 91), such that the locking track 93 and the corresponding locking cam 11 can act as a stop to the longitudinal rearward slip of the knife 90 from the sheath body 90.

In other embodiments, the locking cam 11 may be designed with different sizes and shapes and may be designed to lock and release using other methods (e.g., a palm release for different grip options).

In an exemplary embodiment, the knife retention system as illustrated in FIGS. 1-5 may be operated by one hand. For example, a knife 90 that is locked into the sheath body 10 in the default locking position may be held in a natural grip for holding a knife, e.g., with the thumb placed towards the top of the knife handle 91 proximal to the knife blade 92 and the other fingers cradling the bottom of the knife handle 91. With this grip, the switch portion 12 is readily within the reach of at least the index finger for applying the force to the switch portion 12 to unlock the cam lock 11 and retention system as disclosed herein. The user may press on the switch portion 12 with the index finger to release the knife 90 from the sheath body 10 without changing the hand grip or using the other hand for aid, while the knife 90 is ready for use after release from the sheath body 10 without further changing the user's hand grip.

In an embodiment, the sheath body 10 (with the knife 90 locked to the sheath body 10) may be further clasped or otherwise held to a waist belt worn by the user. In a position where the sheath body 10 is vertically held on the belt such that corresponding knife 90 is held upright with the tip of the blade 92 generally pointing towards the lower body of the user and the knife handle 91 generally pointing towards the upper body of the user, the knife handle 91 may be held similarly as in the natural grip disclosed herein. When the knife 90 is released from the sheath body 10 in this position, the knife 90 is drawn forward (or backward depending on how the knife 90 may be released from the sheath body 10) away from the user's body, which represents a natural arcing movement of the hand or arm (e.g., a flick of the wrist), instead of e.g., drawing (and pulling) the knife 90 upward towards the upper body of the user, which requires flexing of the hand or arm in a more unnatural movement and requires more efforts to be expended by the user. It is noted that this grip is preferred for natural quick draw of the knife 90 facing forward (e.g., with the bottom 21 facing forward) when the knife 90 and the sheath body 10 are belted on the user's waist.

In an alternate embodiment, the user may use an alternate grip with the thumb placed towards the top of the knife handle 91 towards to end of the knife handle 91 distal to the knife blade 92, and the other fingers cradling the bottom of the knife handle 91. With this grip, at least the pinky finger would be the closest and easily within the reach of the switch portion 12 to release the knife 90 similarly to other grip as disclosed herein. It is noted that this alternate grip may be preferred and natural for quick draw of the knife 90 facing backward (e.g., with the bottom 21 facing backward) when the knife 90 and sheath body 10 are belted on the user's waist.

In experimentation and testing, a typical human user is able to quick draw using the knife retention system in under 1 second.

It is noted that the sheath body 10 may be mounted to clips, attachments, and/or other mounting systems as now known or may be later derived.

To return the knife 90 back to the sheath body 10, the blade 92 may be inserted forward with the blade edge of the blade 92 guided into and forward along the interior bottom of the sheath body 10. At some point as blade 92 slides forward along the sheath body 10, the locking cam 11 will contact surface of the knife handle 91 with the locking track 93. The surface will push and rotate the locking cam 11 until the locking cam 11 matches and slips into the opening of the locking track 93, at which point the force supplied by the spring pad 17 will return the locking cam 11 into the locking track 93, putting the retention system back into the locked position.

Referring to FIGS. 1-5, the locking cam 11 is shown as attached to the right side of the sheath body 10. In an embodiment, the locking cam 11 may be attached to the left side of the sheath body, e.g., for convenience or preference of the user in operating the switch portion 12. For example, for locking cam 11 being attached to the right side of the sheath body 10 as shown in FIGS. 1-5, a user may prefer this configuration depending on various factors that affect the user's grip, such as right or left handedness, size of hand, size of finger and distance between the tip and the first joint, etc. In an embodiment, the locking cam 11, the switch portion 12, and/or the sheath body 10 may be sized for universal fit for a typical user. In an embodiment, the attachment 17 may be a pin or other attachment that facilitate easy change of the locking cam 11 from one side of the sheath body 10 to the other side.

In the exemplary embodiment, sheath body 10 is shown as a three bodies construction. In other embodiments, the sheath body could be built using 1 or 2 solid bodies with alternative manufacturing methods and/or materials. In addition, the knife 90 may be built as a single body knife with the handles and the track made from one solid body, instead of multiple bodies.

In an embodiment, sheath body designs may be designed with full enclosure, partial enclosure, or minimal enclosure, of the knife blade.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A knife retention system, comprising:
an longitudinally elongated sheath body configured for holding a blade of a knife along a cutting edge of the blade, wherein a top edge of the blade is uncovered by the sheath body;
a locking cam attached to the sheath body, wherein the locking cam is configured to attach to a handle of the knife when the blade is held by the sheath body in a locked position; and
a release mechanism configured to hold the locked position and to release the blade from the sheath body in an unlocked position upon an application of a force.

2. A knife retention system, comprising:
an longitudinally elongated sheath body configured for holding a blade of a knife along an edge of the blade;
a locking cam attached to the sheath body through an attachment, wherein the locking cam is configured to rotate about the attachment, wherein the locking cam comprises a switch and an insert, and wherein the insert is configured to be inserted into a handle of the knife when the blade is held by the sheath body; and
a spring pad pre-biased to supply a force to rotate the locking cam, wherein the force is configured to keep the insert inserted into the handle,
wherein the switch is configured to receive a counter-force countering the force to rotate the locking cam to release the insert from the handle.

3. The knife retention system of claim 2, further comprising a wall stop configured to stop the locking cam when the locking cam rotates to a position.

4. The knife retention system of claim 2, further comprising a spindle attached to the locking cam, wherein the spring pad supplies the force to an extension of the spindle.

5. The knife retention system of claim 2, wherein the insert is inserted into a corresponding track in the handle.

6. The knife retention system of claim 5, wherein the insert comprises an extrusion, and wherein the track comprises a recess corresponding to the handle.

7. The knife retention system of claim 2, wherein the counter-force is received by a finger of a hand holding the handle.

8. The knife retention system of claim 1, wherein the release mechanism comprises a spring pad.

9. The knife retention system of claim 1, wherein a locking cam attached to the sheath body through an attachment, wherein the locking cam is configured to rotate about the attachment.

10. The knife retention system of claim 1, wherein the force is applied by a finger of a hand holding the handle.

11. The knife retention system of claim 2, wherein the sheath body uncovers a top edge of the blade.

12. A knife retention system, comprising:
a knife;
an longitudinally elongated sheath body configured for holding a blade of the knife along an edge of the blade;
a locking cam attached to the sheath body through an attachment, wherein the locking cam is configured to rotate about the attachment, wherein the locking cam comprises a switch and an insert, and wherein the insert is configured to be inserted into a handle of the knife when the blade is held by the sheath body; and
a spring pad pre-biased to supply a force to rotate the locking cam, wherein the force is configured to keep the insert inserted into the handle,
wherein the switch is configured to receive a counter-force countering the force to rotate the locking cam to release the insert from the handle.

13. The knife retention system of claim 12, wherein the sheath body uncovers a top edge of the blade.

14. The knife retention system of claim 12, wherein the force is applied by a finger of a hand holding the handle.

15. The knife retention system of claim 12, further comprising a wall stop configured to stop the locking cam when the locking cam rotates to a position.

16. The knife retention system of claim 12, further comprising a spindle attached to the locking cam, wherein the spring pad supplies the force to an extension of the spindle.

17. The knife retention system of claim 12, wherein the insert is inserted into a corresponding track in the handle.

18. The knife retention system of claim 17, wherein the insert comprises an extrusion, and wherein the track comprises a recess corresponding to the handle.

19. The knife retention system of claim 2, wherein the locking cam is attached to one side of the sheath body.

20. The knife retention system of claim 2, wherein the locking cam is attached to the sheath body at a position near an end of the sheath body.
